(19) United States
(12) Patent Application Publication
(10) Pub. No.: US 2016/0311493 A1
(43) Pub. Date: Oct. 27, 2016

(54) BICYCLE FRAME

(71) Applicant: Canyon Bicycles GmbH, Koblenz (DE)

(72) Inventor: Lutz Scheffer, Garmisch-Partenkirchen (DE)

(21) Appl. No.: 15/136,116

(22) Filed: Apr. 22, 2016

(30) Foreign Application Priority Data
Apr. 23, 2015 (DE) 202015002990.6

(51) Int. Cl. B62K 19/18; B62K 3/02

(52) U.S. Cl. CPC B62K 19/18; B62K 3/02

(57) ABSTRACT

A bicycle frame which in particular is a mountain bike frame, has a main frame element pivotably connected to a rear frame. The connection is made via an upper longitudinal control arm and a lower longitudinal control arm. A bottom bracket shell is integrated in the lower longitudinal control arm. An upper polar line is arranged such that it extends above a dropout end of the rear frame. It is possible to thereby achieve good riding dynamics.

### BACKGROUND

1. Field of the Disclosure

The disclosure relates to a bicycle frame, in particular a bicycle frame for a mountain bike or a trekking bicycle.

2. Discussion of the Background Art

Bicycles such as in particular mountain bikes often have a suspended rear frame. Such bicycles have a bicycle frame with a main frame element and a rear frame. Here, the main frame element comprises a frame which is designed in particular as a diamond frame including a top tube, a down tube and a seat tube. A rear frame is pivotably connected to the main frame. At its dropout end, the rear frame is connected to a wheel hub of a rear wheel. For suspending the rear frame, the same is hingedly connected to the main frame, with a spring element being provided for damping. A particular design of a bicycle frame is a so-called four-pivot system. Here, the rear frame is connected to the main frame element in a pivotable manner e.g. by two longitudinal control arms. An upper longitudinal control arm is pivotably connected to the rear frame on the one side and to the main frame element on the other hand. The longitudinal control arm further has a protrusion that is connected to a first end of the spring strut, while the second end of the spring strut is connected to the main frame element. The upper longitudinal control arm thus forms two hinges of the four-pivot system. Another, lower longitudinal control arm is pivotably connected to the rear frame on the one hand and is pivotably connected to the main frame element on the other hand. Thereby, two further hinges of the four-pivot system are formed. Depending on the geometric design of the rear frame and on the design and arrangement at the longitudinal control arm, it is possible to realize different frame geometries and, thus, different driving characteristics.

With a bicycle frame having a suspended rear frame, pedal kickback is a problem. The same is caused by the distance between the bottom bracket and the dropout ends becoming larger upon compression of the suspension. This results in a reverse rotation of the chain ring or a rotation of the chain wheel by a certain angle against the drive-effective rotation of the crank. Thereby, a possibly undesired pedal kickback is caused.

Another problem is the so-called squat. This means the compression of the rear frame suspension due to the speed-related change in wheel load. Accordingly, anti-squat relates to the suppression of the suspension compression upon acceleration. When accelerating, a counter force is generated in the chain due to the compression of the suspension and to the pulling forcing of the chain occurring. The same counteracts the acceleration force and therefore has an adverse effect on the acceleration. A known anti-squat measure provides that the chain pulling force causes a decompressing force at the rear frame. This necessarily results in an increased chain pulling force being generated when the rear frame suspension is compressed, which pulling force undesirably turns the crank in the reverse direction against the pedaling direction. This behavior is called pedal kickback. The pedal kickback and the increased chain pulling force upon compression of the suspension do not oppose acceleration under mechanical aspects. Under bio-mechanical aspects the pedal kickback clearly interferes with pedaling.

In order to reduce the effect of the pedal kickback and to still generate an effective anti-squat, it is possible to provide the bottom bracket shell not fixed to the main frame element, but to connect it rigidly with the lower longitudinal control arm. This has the effect that the position of the bottom bracket shell changes during the compression and the decompression of the suspension. Such an arrangement of the bottom bracket shell is known for example from DE 2005 036 610.

It is an object of the disclosure to provide a bicycle frame, in particular for a mountain bike or a trekking bicycle, which, when a suspended rear frame is provided, has positive riding dynamics.

### SUMMARY

A bicycle frame, in particular a bicycle frame for a mountain bike or a trekking bicycle with a suspended rear frame, comprises a main frame element. In particular, the main frame element is a so-called diamond frame, although other frame designs are also possible. Specifically, the main frame element has a top tube, a down tube and a seat tube. A suspended rear frame is connected to the main frame element. The rear frame typically comprises a pair of chain stays, as well as one or particularly also a pair of seat stays. At the end directed rearward with respect to the traveling direction, the chain stays have a dropout end. This serves to receive the rear wheel hub or the rear wheel axle. The at least one, in particular two seat stays preferably extend from the dropout end in a preferably upwardly slanted direction towards the seat tube. Preferably, at least one chain axle is connected to a seat stay through a connecting stay. In particular, the three stays are rigidly connected with each other, it being further preferred that the three stays form a triangle is side view.

In the design of the bicycle frame according to the disclosure, a suspended rear frame is formed by connecting the same to the main frame element by means of two longitudinal control arms. The upper longitudinal control arm is pivotably connected to the main frame element by means of an upper frame axle. It is preferred that the upper longitudinal control arm is pivotable at least through a certain angular range. Further, the upper longitudinal control arm is pivotably connected to the rear frame by means of an upper rear frame axle. The connection between the rear frame and the upper longitudinal control arm via the upper rear frame axle is preferably designed such that, in the mounted state, the upper rear frame axle is arranged between the rear wheel and the seat tube of the main frame element. It is further preferred that the upper longitudinal control arm is connected to an end of a damping element. In this regard, the upper longitudinal control arm may have an additional protrusion, for example. A second end of the damping element is preferably connected to the main frame element. However, the damping element may also be arranged between the lower longitudinal control arm and an element of the main frame.

In the bicycle frame of the present disclosure, the lower longitudinal control arm is preferably pivotably connected to the main frame element via a lower frame axle and is pivotably connected to the rear frame via a lower rear frame axle. It is an essential element of the disclosure that a bottom bracket shell is preferably rigidly connected to the lower longitudinal control arm. This causes a change in the position of the bottom bracket shell during compression or decompression of the suspension. Thereby, given a corresponding geometric design, the riding dynamics, in particular the pedal kickback and anti-squat, can be influenced in a positive manner. Such a bottom bracket shell connected to the lower longitudinal control arm is a so-called floating bottom bracket.

An upper polar line is formed by a connecting line between the upper frame axle connecting the upper longitudinal control arm with the main frame element and the upper rear frame axle connecting the upper longitudinal control arm with the rear frame. According to the disclosure the upper polar line is directed such that it extends above the dropout end of the rear frame supporting the rear wheel axle. This is true in particular in the compressed state, but preferably also in the decompressed state. It is particularly preferred that the upper polar line ascends in the direction of travel.

Improved riding dynamics can already be achieved with the above described design of a suspended bicycle frame, where it is possible to achieve an improvement of riding dynamics in particular due to the combination of the position of the upper polar line above the dropout end and the bottom shell connected to the lower longitudinal control arm. In particular, pedal kickback can be reduced thereby, where it should be considered that a possible slight pedal kickback is not perceived as disturbing by the cyclist. It should further be considered that the magnitude of pedal kickback also depends on the gear position of the chain. The design according to the disclosure may also positively influence the anti-squat.

In a preferred embodiment of the bicycle frame of the disclosure a distance between the lower frame axle of the lower longitudinal control arm and the middle axis of the bottom bracket shell is 50 mm to 100 mm, in particular 50 mm to 70 mm. In particular, the distance between the lower frame axle and the middle axis of the bottom bracket shell is constant independent of the compression state of the suspension. This has the effect that, in the event of suspension movements of the rear frame, the bottom bracket moves on a circular line with a corresponding radius. Due to the corresponding movement, the distance between the rear dropout end and the middle axis of the bottom bracket shell changes. Depending on the compression state of the suspension, this causes a change in pedal kickback and also in anti-squat.

It is further preferred that the defined geometry of the lower longitudinal control arm is given in particular in dependence on the maximum suspension travel of the damping element. According to the disclosure it is preferred that the distance of the lower frame axle of the lower longitudinal control arm to the lower rear frame axle of the lower longitudinal control arm is 80% to 160%, in particular 100% to 140% of a defined suspension travel. The suspension travel is the maximum resulting suspension travel of the rear axle upon compression of the suspension.

In a further preferred development of the disclosure a lower polar line is formed by a connecting line between the lower frame axle of the lower longitudinal control arm and the lower rear frame axle of the lower longitudinal control arm. In a preferred embodiment, according to the disclosure, the angle of the lower polar line with the horizontal line is from 20° to 40°, in particular 25° to 345°, in the decompressed state of the suspension of the rear frame. It is particularly preferred that both the lower and the upper polar line are designed to be ascending. Thereby, a further improvement of the riding dynamics can be achieved.

Further, it is preferred in the interest of improving the riding dynamics that, in particular in the decompressed state of the suspension of the rear frame, the upper polar line and the lower polar line form an angle of less than 10°, in particular less than 5°, with each other. It is particularly preferred that the two polar lines are parallel to each other in the decompressed state of the suspension of the rear frame.

Based on the two polar lines, an overall polar line can be determined. The overall polar line of the bicycle frame is formed by a line between the rear wheel axle and an intersection between the upper and lower polar lines. With the lower and upper polar lines parallel to each other, the overall polar line is a line also parallel to the other two lines and extending through the rear wheel axle. It is preferred that the overall polar line ascends in the traveling direction. In a compression state of the suspension, which results from the static load of the cyclist (ca. 20-30% of the total suspension travel), the so-called SAG, it is preferred that the overall polar line forms an angle of 5°-30°, in particular 10° to 15°, with the horizontal line.

SAG is understood as a state in which the bicycle is statically loaded by the weight of the cyclist. In this state, the spring element is adjusted such that a certain compression (typically 20-30% of the total suspension travel) of the spring element is given. This is necessary to allow the decompression of the rear frame suspension when riding over a pot hole or the like. The SAG is adjusted in dependence on the weight of the cyclist such that the damping element is prevented from bottoming out during regular use of the bicycle. In this regard, the damping hardness is also adjusted, e.g. by means of compressed air, such as the inner air pressure of the air spring strut (ca. 5-15 bar). With a coil spring strut, the adjustment is made by adapting the spring rigidity of the coil spring and, in case of minor adjustments, by pre-stressing the coil spring.

The disclosure preferably consists in particular in that an effective anti-squat is generated only by a large deflection angle (overall polar line ascending, under SAG, by 5° to 25° with respect to the traveling direction). When decompressed, the overall polar line ascends by 20° to 35°. The inclination of the overall polar line corresponds to the deflection angle.

The geometric arrangement and design of the bicycle frame, in particular of the rear frame and the two longitudinal control arms, are adjusted to each other in an advantageous manner. In this regard, in particular a combination of the above described embodiments is advantageous.

Further, it is particularly advantageous if the distance between the upper frame axle ad the upper rear frame axle of the upper longitudinal control arm is smaller than the distance between the lower frame axle and the lower rear frame axle of the lower longitudinal control arm. Preferably, with the upper longitudinal control arm, this distance is 25%-100% and in particular 30%-60% of the corresponding axle distance at the lower longitudinal control arm.

Positive riding dynamics may also be achieved by the polar line having a vertical distance from the dropout end of the rear frame, when in the decompressed state, that exceeds 50% of the maximum suspension travel of the damping element. Preferably, this distance is greater than 60 mm. Preferably, the vertical distance of the upper polar line from the dropout end is 25%-150% and particularly preferred 50% to 75% of the maximum suspension travel of the damping element.

In a preferred development a middle axis of the bottom bracket shell under SAG is situated vertically below the lower frame axle with a deviation of ±20°, in particular ±10°.

Moreover, it is particularly preferred that the lower rear frame axle of the lower longitudinal control arm is arranged such that it is situated within a wheel circle of a mounted rear wheel. In case of a rear wheel mounted in the rear dropout ends by the rear wheel axle, the lower rear frame axle of a particularly preferred embodiment is thus situated within the wheel circle and preferably within the rim ring. Again, it is preferred that the lower rear frame axle is not too close to the dropout end. It is particularly preferred that the rear frame axle is arranged near the wheel circle.

Another preferred design and arrangement of the two longitudinal control arms is such that the two longitudinal control arms rotate in the same direction when the damping element is compressed and decompressed. It is particularly preferred that, upon compression, the two longitudinal control arms turn in the traveling direction, i.e. clockwise, and turn counterclockwise upon decompression.

In another preferred embodiment the wheel deflection trajectory is directed obliquely rearward with respect to the traveling direction. In particular under SAG, the wheel deflection trajectory forms an angle of less than 90° with a horizontal line, in particular an angle of 65°-80° and particularly preferred an angle of 70°-75°.

With such a rearward inclined wheel deflection trajectory the anti-squat effect of the frame can be enhanced significantly. Compared to the bicycle rising trajectory of the present disclosure, conventional single or four-pivot systems have a wheel deflection trajectory of ca. 90° relative to the horizontal line, when under SAG.

With bicycle frames of the present disclosure, in particular the above described developments of the present disclosure, riding dynamics are clearly improved. Specifically, undesired suspension movements, such as an undesired compression when starting to pedal, are avoided or at least largely reduced. Further, with the present-disclosure design of the bicycle frame, a rear frame movement induces no or at least a significantly reduced undesirable pedal movement. According to the disclosure this very slight or in particular non-existent pedal kickback is always very slight independent of the selected gear combination. This is particularly favorable with an active suspension so as to be able to transmit a high driving torque, seen under biometrical aspects. Despite the significant reduction of this pedal movement achieved by the present disclosure due to a purposeful decoupling, a significant anti-squat effect is obtained that is independent of the chain pulling force. In particular, according to the disclosure, the anti-squat effect is between 50% and 150%, in particular between 80% and 120% depending on the gear selected. Here, depending on the calculation method, the anti-squat value is given in percent. 100% anti-squat means a frame entirely free from pitching. Values higher than 100% represent an overcompensation (decompression during acceleration). Values lower than 100% represent an only partial compensation (rear suspension is slightly compressed during acceleration).

This anti-squat effect may be achieved in particular by means of the deflection angle provided by the present disclosure. The deflection angle is the angle formed by the overall polar line with a horizontal line which, according to the disclosure, preferably is in a range from 5° to 25°, in particular 10° to 15°, when under SAG.

It is another advantage of the bicycle frame of the present disclosure that due to the decoupling of the chain pulling force from the suspension movement, the hardening of the suspension is less. This is due to the fact that the mass of the cyclist standing on the pedal crank does not have to be lifted, as is usually the case. Further, there is an advantage that, compared to conventional suspension systems, a significant anti-squat effect can be obtained with the bicycle frame of the present disclosure without having to accept a pedal kickback that is not insignificant. According to the disclosure, it is possible to realize a significant anti-squat effect without or with only a slight pedal kickback. Owing to the bicycle frame geometry and design of the present disclosure, in particular in the preferred embodiments, a significant anti-squat effect can be achieved independent of the selected gear.

Because of the integration of the bottom bracket shell into the lower longitudinal control arm, it is possible to realize an at least substantially constant distance between the rear wheel axle and the crank axle. Insofar it is possible to provide a toothed belt drive instead of a chain.

Further, the bicycle frame of the present disclosure is advantageous in that a so-called suspension rattling no longer occurs or is at least largely reduced. With conventional bicycle frames, a movement of the chain tension occurs due to the changing distance between the rear wheel axle and the bottom bracket axle. This movement occurs with an audible noise of hitting against the non-return device of the freewheel device at the rear wheel. Due to the substantially constant distance between the rear wheel hub and the pedal axle of the bicycle frame of the present disclosure, the rattling does not occur or is at least largely reduced.

It is another advantage of the bicycle frame of the present disclosure, which is realized in particular by the large deflection angle, that impulses occurring when rolling over obstacles are absorbed well by the suspension. This is due to the fact that the force direction of the impact impulse substantially corresponds to the deflection direction of the rear wheel.

Another advantage of the deflection angle of the present disclosure is that dynamic, primarily vertical movements of the cyclist, as they occur for example when riding out of the saddle, are induced into the suspension only in a low degree.

The following is a detailed explanation of the disclosure with reference to a preferred embodiment and to the accompanying drawings.

### BRIEF DESCRIPTION OF THE DRAWINGS

In the Figures:

FIG. 1 is a schematic side view of a bicycle with a bicycle frame of the present disclosure in the decompressed state of the suspension, and

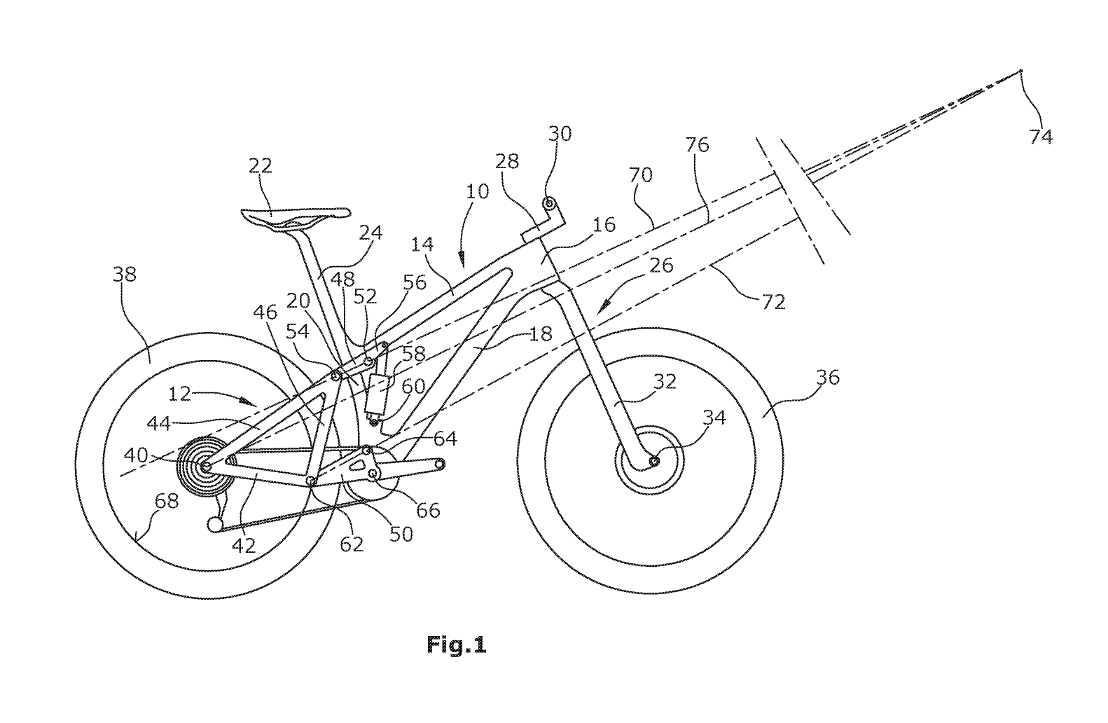

FIG. 2 is a side view of the bicycle illustrated in FIG. 1 when under SAG.

### DETAILED DESCRIPTION OF THE PREFERRED EMBODIMENT

In the embodiment illustrated a main frame element 10 is hingedly connected to a rear frame 12. The main frame element 10 in the embodiment illustrated has a top tube 14, a down tube 18 connected to the top tube via a steer tube 16, as well as a seat tube 20 connecting the down tube 18 to the steer tube 16. The seat tube 20 serves to receive a seat post 24 supporting the seat 22. A front wheel fork 26, which in the present embodiment is a suspended fork, is arranged in the steer tube 16 and is connected to a handlebar 30 via a handlebar stem 28. A front wheel axle of a front wheel 36 is mounted to the two fork legs 32.

At the rear dropout ends 40, a rear wheel 38 is mounted by a rear wheel axle. The rear dropout ends 40 are arranged opposite each other, given that the chain stays 42 are arranged opposite each other. In particular, in the embodiment illustrated also two opposite seat stays 44 are provided which in the region of the dropout end 40 are respectively connected to the corresponding chain stay 42, in particular in a rigid manner. Further, the seat stays 44 are connected, in particular in a rigid manner, to the chain stays 42 by a respective connecting stay 46, with the three stays 42, 44, 46 forming a triangle in side view.

Further, an upper longitudinal control arm 48, as well as a lower longitudinal control arm 50 is connected to the main frame element 10. In the embodiment illustrated the upper longitudinal control arm 48 is pivotably connected to the top tube 14 of the main frame element 10 via an upper frame axle 52. Another pivotable connection is realized by an upper rear frame axle 54 forming a pivotable connection between the upper longitudinal control arm 48 and the rear frame 12. Further, the upper longitudinal control arm 48 has a protrusion 56. At a free end of the protrusion 56, a damping element 58 is connected to the protrusion 56, again in a pivotable manner. A lower end 60 of the damping element 58 in the embodiment illustrated is connected to the main frame element by a protrusion of the seat tube.

The upper rear frame axle 54 is connected in particular to the opposing seat stays 44, the connection being made preferably in the region of the connection between the seat stays 44 and the connecting stays 46. The lower longitudinal control arm 50 is pivotably connected to the rear frame 12 via a lower rear frame axle 62, the connection being made in particular to the chain stay 42 and, in the embodiment illustrated, in the region of the connection between the chain stay 42 and the connecting stay 46.

Further, the lower longitudinal control arm 50 is pivotably connected to the main frame element 10 via a lower frame axle 64, the connection being made in particular in the region of the connections between the seat tube and the down tube 18.

In the embodiment illustrated, a bottom bracket shell 66 for receiving the pedal crank bearing is rigidly connected to the lower longitudinal control arm 50 or as an integral part of the lower longitudinal control arm 50. In this regard, the lower longitudinal control arm may be triangular in shape for reasons of stiffness.

In the depicted particularly preferred embodiment of the bicycle frame of the present disclosure the lower rear frame axle 52 is formed by two opposite hinges, each of which is arranged laterally beside the rear wheel 38, seen in the traveling direction. Here, it is preferred that, corresponding to the illustration, the lower rear frame axle 62 is formed within a wheel perimeter 68 defined by the rim of the rear wheel 38.

A connecting line through the upper rear frame axle 54 and the upper frame axle 52 of the upper longitudinal control arm 48 forms an upper polar line 70. A connecting line between the lower rear frame axle 62 and the lower frame axle 64 of the lower longitudinal control arm 50 forms a lower polar line 72.

If the two polar lines 70, 72 are arranged under an angle with respect to each other, an intersection 74 is obtained which in the embodiment illustrated is located ahead of the handlebar 30, seen in the traveling direction. The angle between the two polar lines 70, 72 is preferably smaller than 10°, provided that the polar lines are not parallel to each other as in a particularly preferred embodiment.

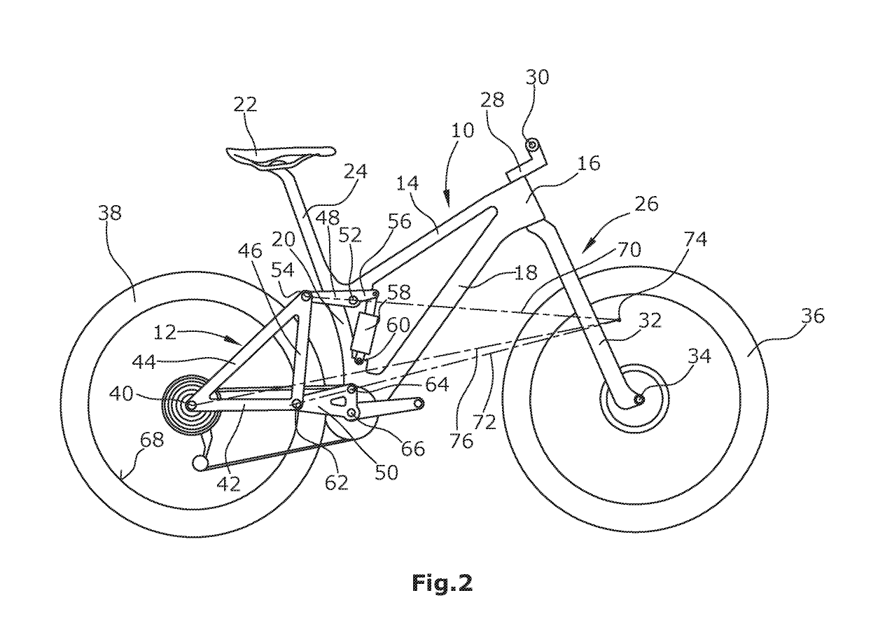

A connecting line between the dropout ends 40 receiving the rear axle and the intersection 74 forms the common polar line 76. In a slightly compressed state of the suspension, i.e. under SAG, the common polar line 76 forms an angle of 10° to 15° with a horizontal line (FIG. 2).

What is claimed:

1. A bicycle frame, in particular a mountain bike frame, comprising
a main frame element,
a rear frame movably connected to the main frame element in order to form a suspended bicycle frame,
an upper longitudinal control arm and a lower longitudinal control arm, each connecting the rear frame to the main frame element,
the upper longitudinal control arm being pivotably connected to the main frame element via an upper frame axle and to the rear frame via an upper rear frame axle,
a connecting line between the upper frame axle and the upper rear frame axle forming an upper polar line extending above a dropout end of the rear frame, and
the lower longitudinal control arm preferably being rigidly connected to a bottom bracket shell.

2. The bicycle frame of claim 1, wherein the lower longitudinal control arm is pivotably connected to the main frame element via a lower frame axle and to the rear frame via a lower rear frame axle.

3. The bicycle frame of claim 2, wherein the distance of the lower frame axle to the middle axis of the bottom bracket shell is from 50 mm to 100 mm.

4. The bicycle frame of claim 2, wherein the distance between the lower frame axle and the lower rear frame axle is 80% to 160% of a resulting suspension travel at the rear wheel.

5. The bicycle frame of claim 2, wherein a connecting line between the lower frame axle and the lower rear frame axle forms a lower polar line which in the decompressed state of the suspension forms an angle of 20° to 40° with a horizontal line.

6. The bicycle frame of claim 2, wherein the distance between the upper frame axle and the upper rear frame axle is from 25% to 100% of the distance between the lower frame axle and the lower rear frame axle and/or that the distance between the upper frame axle and the upper rear frame axle is between 80 mm and 150 mm.

7. The bicycle frame of claim 5, wherein the upper polar line forms an angle of less than 10° with respect to the lower polar line, and wherein it is particularly preferred that the two polar lines extend parallel to each other.

8. The bicycle frame of claim 1, wherein, in the decompressed state of the suspension, the upper polar line is spaced vertically from the dropout end of the rear frame by more than 50% of the suspension travel of a suspension element and/or by more than 60 mm.

9. The bicycle frame of claim 1, wherein, under SAG, an overall polar line forms an angle of 5° to 25° with respect to a horizontal line.

10. The bicycle frame of claim 1, wherein, under SAG, a middle axis of the bottom bracket shell is arranged below the lower frame axle with a deviation of ±20°.

11. The bicycle frame of claim 1, wherein the lower rear frame axle is arranged within a wheel perimeter of a mounted rear wheel.

12. The bicycle frame of claim 1, wherein upon compression/decompression of the suspension, the two longitudinal control arms turn in the same direction.

13. The bicycle frame of 1, wherein, in particular under SAG, a wheel deflection trajectory extends obliquely rearward, wherein it is preferred that, under SAG, the wheel deflection trajectory forms an angle of less than 90° with the horizontal line.

14. The bicycle frame of claim 2, wherein the distance of the lower frame axle to the middle axis of the bottom bracket shell is from 50 to 70 mm.

15. The bicycle frame of claim 2, wherein the distance between the lower frame axle and the lower rear frame axle is 100% to 140% of a resulting suspension travel at the rear wheel.

16. The bicycle frame of claim 2, wherein a connecting line between the lower frame axle and the lower rear frame axle forms a lower polar line which in the decompressed state of the suspension forms an angle of 25° to 35° with a horizontal line.

17. The bicycle frame of claim 2, wherein the distance between the upper frame axle and the upper rear frame axle is from 30% to 60% of the distance between the lower frame axle and the lower rear frame axle and/or that the distance between the upper frame axle and the upper rear frame axle is between 80 mm and 150 mm.

18. The bicycle frame of claim 5, wherein the upper polar line forms an angle of less than 5° with respect to the lower polar line, and wherein it is particularly preferred that the two polar lines extend parallel to each other.

19. The bicycle frame of claim 1, wherein, under SAG, an overall polar line forms an angle of 10° to 15° with respect to a horizontal line.

20. The bicycle frame of claim 1, wherein, under SAG, a middle axis of the bottom bracket shell is arranged below the lower frame axle with a deviation of ±10°.

21. The bicycle frame of 1, wherein, in particular under SAG, a wheel deflection trajectory extends obliquely rearward, wherein it is preferred that, under SAG, the wheel deflection trajectory forms an angle in the range between about 65°-80° with the horizontal line.

22. The bicycle frame of 1, wherein, in particular under SAG, a wheel deflection trajectory extends obliquely rearward, wherein it is preferred that, under SAG, the wheel deflection trajectory forms an angle in the range between about 70°-75° with the horizontal line.
